(19) United States
(12) Patent Application Publication
(10) Pub. No.: US 2001/0046622 A1
(43) Pub. Date: Nov. 29, 2001

(54) Means and method for convenient marking of an article or battery

(76) Inventor: Morris L. Barwick, Denville, NJ (US)

Correspondence Address: Morris Barwick, 19 E. Shore Rd, Denville, NJ, 07834, US

(21) Appl. No.: 09/777,812

(22) Filed: Feb. 6, 2001

Related U.S. Application Data
(60) Provisional application No. 60/199,056, filed on Apr. 22, 2000.

(51) Int. Cl. H01M 10/48; H01M 2/34; H01M 2/02

(52) U.S. Cl. 429/90; 429/91; 429/176

(57) ABSTRACT

An indicator of battery charge is disclosed which is incorporated into a battery to allow persons possessing knowledge of remaining battery capacity to easily modify tactile and visual characteristics of said battery as an indication of remaining charge. Said characteristics are, but not limited to, coatings, attachments for removal and devices, which can be altered in form.

### CROSS-REFERENCE TO RELATED APPLICATIONS 5,360,682 BATTERY CHARGE INDICATOR APPARATUS AND THE METHOD OF OPERATION THEREOF Current U.S. Class: 29191; 429/70 Internl Class: H01M 010/48 Field of search: 429/90

### STATEMENT REGARDING FEDERALLY SPONSORED RESEARCH OR DEVELOPMENT Not applicable.

### BACKGROUND OF THE INVENTION

The existing state of charge of a battery is usually known by the person removing said battery from service and my invention provides the ability to mark said knowledge onto said battery for later segregation and selection.

All present methods of establishing the charge content of a battery are based on electrical testing or observations of chemical actions therein and the display of the results. The most prevalent method available to the lay consumer today is by use of a temperature indicating liquid crystal strip incorporated in the label, Said liquid crystal strip displays a color varying as a function of its temperature, which is elevated by and proportional to the flow of electrical current therein. The flow of said electrical current is proportional to the voltage impressed thereon by the battery under test.

The use of this strip requires that two points on the liquid crystal be forced against the battery terminals, thereby causing electrical current flow in the said liquid crystal. This current flow creates heat and the liquid crystal changes color indicating the temperature it has acquired and thereby, the amount of voltage existing at the battery terminals. The disadvantages arising out of use of this method are:

(a) In order to generate sufficient electrical contact in two places, awkard amounts of fingernail pressure must be applied at those two contact spots.

(b) The liquid crystal temperature also reflects the temperature of the surrounding air and battery. It is rated at 72 Degrees F. and if self-temperature begins above that temperature, it will cause an indication of “GOOD” even though that amount of energy is not contained in said battery. Conversely, at colder temperatures, the liquid crystal cannot achieve the required indicating temperature resulting in an indication of “WEAK” even though said battery is indeed good and is suitable for service.

(c) The use of this method of battery evaluation is not available to those persons of limited sight nor in use in a reduced lighting environment.

(d) The impulse is to discard said battery immediately upon determination without considerations of recycle services. If retained for later recycling, it implies re-testing to verify battery has not been intermixed with new batteries.

(e) The expense of manufacturing.

U.S. Pat. No. 5,360,682 contains some construction features which appear substantially similar to my invention claim number 3. It is noted that in said patent, indication is caused by internal chemical action and not by actions of any intelligence, thereby avoiding any conflict with my invention. Both the expense of incorporation and the limitation of being applicable only to alkaline batteries limit it.

The most reliable way of determination of state of charge is by using a voltmeter to measure voltage while said battery is delivering a known current. This requires instrumentation not normally used in the field or available to lay consumer at any time.

### BRIEF SUMMARY OF THE INVENTION

In accordance with the present invention an article, including but not limited to a battery, can be easily and conveniently marked without aid of instruments, to record information thereon.

Accordingly, besides the objects and advantages of the marking methods described in my above patent, several objects and advantages of the present invention are:

(a) to provide a method of marking said article which by virtue of surface modification, can be detected also by those of limited sight;

(b) to provide a convenient method, which can be incorporated either at manufacture or in after market, of marking an article;

(c) to provide a method of marking an article in order to indicate in which of two possible states the article now exists;

(d) to allay fears of user of said battery of future intermingling of usable with unusable batteries thereby improving the possibility that dead batteries will be disposed of properly at a later time;

(e) to provide battery condition indication without being misinformed by the existing temperature of said battery;

(f) to provide a means for identification of said article without imparting significant increase in size or manufacturing cost to said article.

(g) to solve the problem of mating a good battery with a weak battery in a device and not knowing which battery is from earlier service and should be discarded.

### BRIEF DESCRIPTION OF THE SEVERAL VIEWS OF THE DRAWING

FIGS. 1A to 1D Illustrates the four stages in the life of a battery and the preferred embodiment of my invention for identifying each stage by the use of removable coatings.

FIGS. 2A to 2D Illustrates the four stages in the life of a battery and an alternate embodiment of my invention for identifying each stage by the use of tabs, which can be removed by pull.

FIGS. 3A to 3D Illustrates an alternate embodiment of my invention used only to identify said battery as being new or dead, by use of a bladder containing colored fluid and subject to rupture,

FIGS. 4A and 4B Illustrates an alternate embodiment of my invention used only to identify said battery as being new or dead, by use of a tear strip which can be removed by pull.

FIGS. 5A to 5 Illustrates an alternate embodiment of my invention using a two positional marker for use in identifying in which, of two possible, stages an article presently exists.

### REFERENCE NUMERALS IN DRAWINGS

110 Removable coatings as supplied on a new battery.

120 Instructional markings on action to be taken if the battery is removed from service while still containing future service.

130 Instructional markings on action to be taken if the battery is removed from service when containing no future service value.

140 USED marking beneath covering coating exposed by the removal of said coating.

150 DEAD marking beneath covering coating exposed by the removal of said coating.

210 Removable tabs as supplied on a new battery.

220 Instructional markings on action to be taken if the battery is removed from service while still capable of future service.

230 Instructional markings on action to be taken if the battery is removed from service when containing no future service value.

240 USED marking beneath tab exposed by the removal of said tab.

250 DEAD marking beneath covering tab exposed by the removal of said tab.

310 Transparent or translucent film attached at the edges or periphery of said film to the surface of a new battery.

320 Instructional markings on action to be taken if said battery is removed from service when containing no future service value.

330 An opaque area in or on said film 310 which obscures all objects behind and beneath said opaque area.

340 A bladder beneath or behind, and obscured by said opaque area 330.

350 A colored fluid contained in said bladder 340.

410 A pull strip on the surface of a new battery,

420 Instructional markings on action to be taken when said battery is removed from service when containing no future service value.

430 A free end of said pull strip facilitating grasping said pull strip for pulling from surface of said battery.

510 A transparent or translucent film attached at edges or periphery and forming two chambers or volumes connected by channel 560.

520 Instructional markings on action to be taken after charging said battery.

530 Instructional markings on action to be taken when recharging of said battery is deemed necessary.

540 Highly viscous colored fluid between the transparent film 510 and the surface of the battery.

550 Charged status marking of rechargeable battery beneath transparent film 510.

560 Restrictive channel between two said volumes formed by film 510.

570 Discharged status marking of rechargeable battery beneath said transparent film 510.

### DETAILED DESCRIPTION OF THE INVENTION

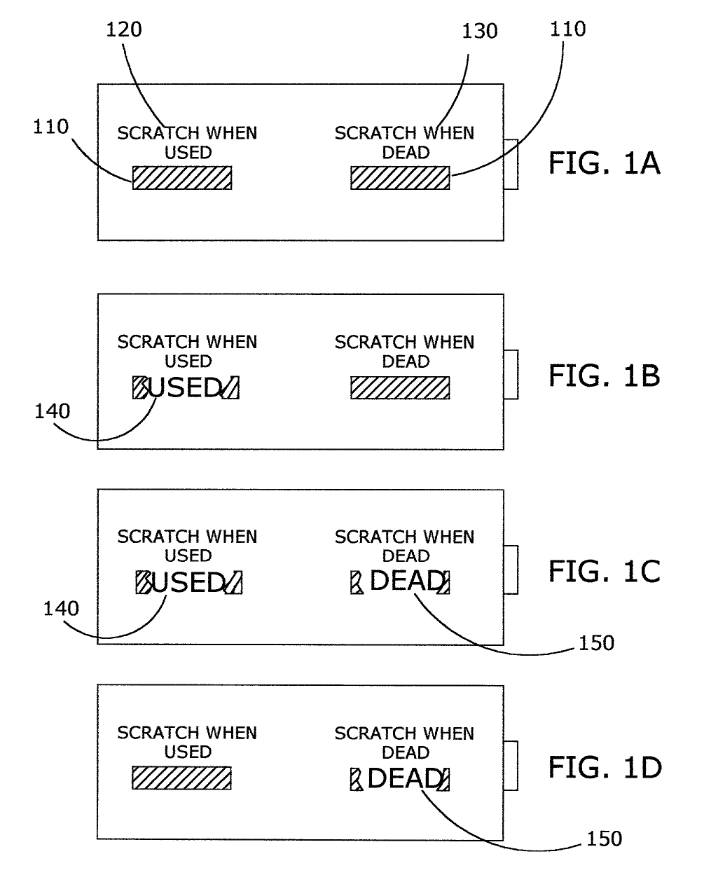

A preferred embodiment of my method of marking for later identification of a battery is shown in FIG. 1A and is a new battery containing coatings 110 capable of being removed with ease. Said battery also contains instructional markings 120 on action to be taken if said battery is removed from service while still containing future service and instructional markings 130 on action to be taken if said battery is removed from service when containing no future service value. This embodiment shows covering coatings 110 as containing no markings. This does not preclude the incorporation of markings 120 and 130 in said covering coating 110 itself.

When removing said battery from a device or service, person removing said battery knows if it was removed by virtue of being totally exhausted of charge and of no further use, or if said battery contains enough charge to be useful in future application of lesser importance. That knowledge is recorded on said battery by scratching the appropriate coated area thereby exposing relevant message to view.

FIG. 1B is said battery of FIG. 1A when removed from service while still containing some future service life. When removing said battery from a device or service, person removing said battery knows if it was removed while said battery contains enough charge to be useful in future application of lesser importance. Covering coating 110 is removed from position indicated by the instructional markings 120 by scratching or rubbing, thereby exposing markings 140 beneath said coating 110 and thereby recording the knowledge the person doing the marking had about said battery at time of removal from service. FIG. 1C is said battery of FIG. 1B when subsequently removed from the service of lesser importance at the end of useful life of said battery. At the time of removal from service, coating 110 is removed from the area directed by the instructional markings 130 thereby exposing markings 150 beneath said coating 10 identifying said battery as being of no future value.

FIG. 1D Shows said new battery of FIG. 1A after having been removed from service only when dead or completely exhausted. At the time of removal, the coating 110 is removed as directed by instructional marking 130. Since there was no interim usage of said battery; coating 110 was never removed in accordance with instructions of 120.

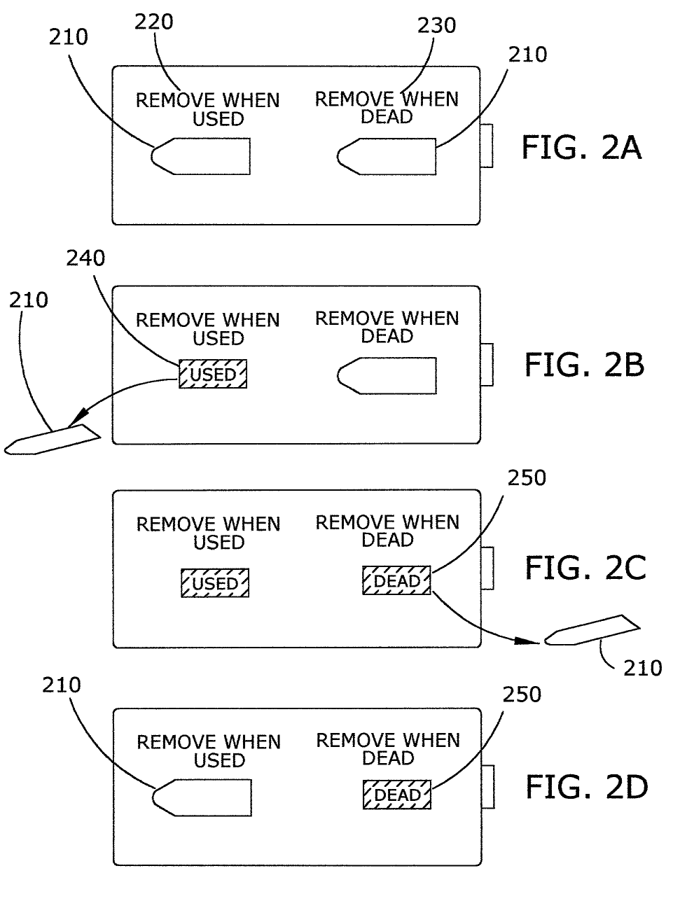

FIGS. 2 to 5 Alternative Embodiments.

FIG. 2A is a new battery containing removable tabs 210 capable of being removed with ease. This embodiment shows tabs 210 as containing no markings. This does not preclude the incorporation of markings on tabs 210 itself. Said battery also contains instructional markings 220 on action to betaken if said battery is removed from service while still containing future service and instructional markings 230 on action to be taken if said battery is removed from service when containing no future service value.

FIG. 2B is said battery of FIG. 2A when removed from service while still containing some future service life, though of lesser reliability. Covering tab 210 is removed from the position indicated by the instructional markings 220 thereby exposing markings 240 beneath said tab 210 recording the knowledge the person doing the marking had about said battery at time of removal from service.

FIG. 2C is said battery FIG. 2B of when subsequently removed from secondary service at the end of useful life of said battery. At the time of removal, tab 210 is removed from the area directed by instructional markings 230 thereby exposing markings 250 beneath said tab 210 identifying said battery as being of no future value.

FIG. 2D Shows said new battery of FIG. 2A after having been removed from service only when dead or completely exhausted. At the time of removal, tab 210 is removed as directed by instructional marking 230. Since there was no interim usage of said battery, tab 210 was never removed in accordance with instructions of 220.

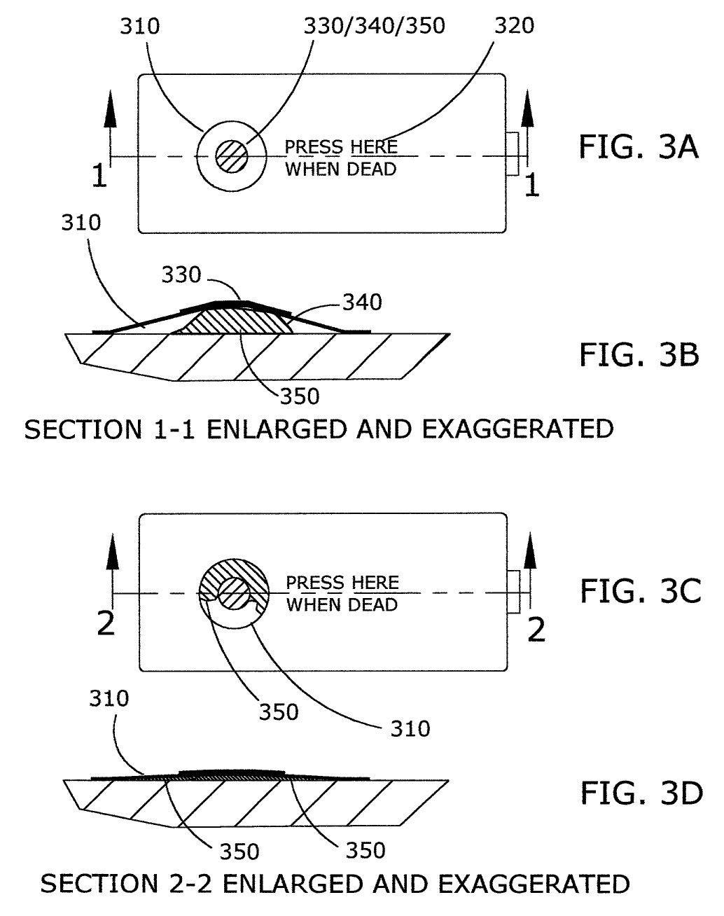

FIG. 3A is a new battery containing a transparent or translucent film 310 attached at the edges or periphery to surface of said battery. Near to the transparent film 310 are instructions 320 on action to be taken when said battery is known to be dead. Located on or in the transparent film 310 is an opaque area 330 which prevents the observation of a sealed bladder 340 containing a colored fluid 350 and located behind and beneath the film 310 and opaque area 330.

FIG. 3B Is an enlargement of cross section of said battery of FIG. 3A with shape exaggerated for clarity. FIG. 3C shows said battery of FIG. 3A when found to be totally dead and without future value. At the time of discernment of exhausted condition, a force is exerted by the person with said knowledge of exhaustion at the opaque area 330 on the bladder 340 beneath in accordance with instructions 320 causing rupture of said bladder 340. Rupture of said bladder 340 allows the colored fluid 350 to flow from beneath the opaque area to where it may be viewed through the transparent film 310 indicating said battery is of no future value. Said colored fluid 350 is still constrained by the sealed edges of the transparent film 310 and is not allowed to escape.

FIG. 3D Is a 4 times enlargement cross section of said battery of FIG. 3C after bladder 340 having been ruptured by the application of external force upon the opaque area 330. Diagram is also exaggerated in size for clarity

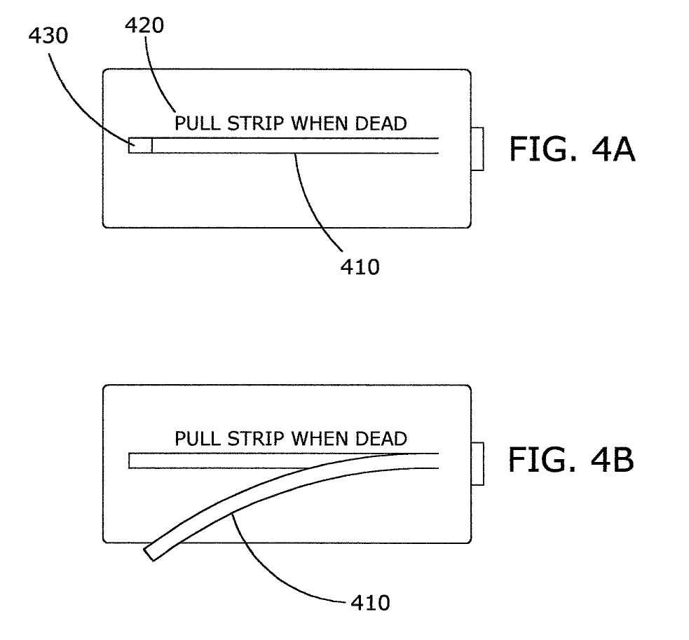

FIG. 4A shows a new battery, which contains a strong elongated membrane strip 410, embedded in or attached to the battery covering. Adjacent to or contained on said strip 410 are instructions 420 on action to be taken when said battery is known to be dead. The removal of said strip 410 is facilitated by the existence of a free end 430, which can be grasped and pulled.

FIG. 4B shows said battery FIG. 4A upon removal from service after having the pull strip 410 separated from said battery FIG. 4A in accordance with instructions 420 thereby indicating said battery is of no future value. Note that one end of pull strip 410 may remain attached to battery to prevent clutter.

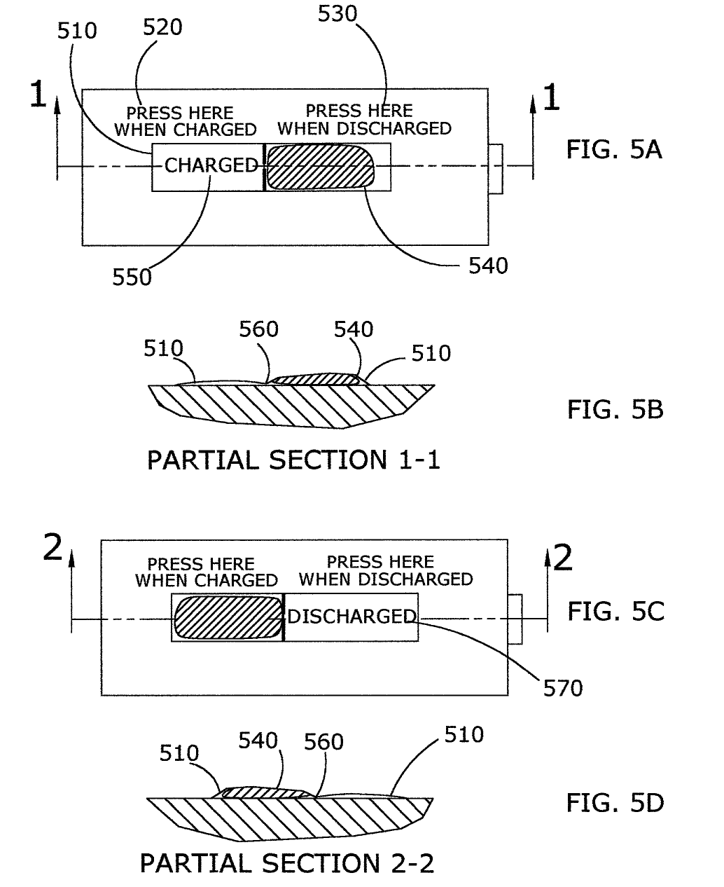

FIG. 5A shows a rechargeable battery in the charged state. The surface of the battery contains a transparent or translucent covering film 510 bonded and sealed at all edges. Messages 520 and 530 are instructional for the person either removing said battery from service or completion of recharging of said battery.

FIG. 5B is a cross section of battery of FIG. SA in the charged state. Beneath film 510 ate two chambers capable of containing a highly viscous fluid 540 which obscures message 570, making only message 550 visible by virtue of the position of fluid 540. Between these two chambers is a connecting channel 560 containing an obturator, which is normally closed but may be overcome and temporarily opened by increased pressure in the fluid.

FIG. 5C In order to change the observable message from 550 to 570, the fluid pressure in one chamber is increased by the application of finger force to the covering film on the side containing said fluid, thereby causing an increase in pressure within that chamber causing the connecting channel 560 to open and allow the fluid to pass to the other chamber. The previously obscured message on the side of the applied force now becomes visible and the fluid 540 now obscures the previously visible message 550.

FIG. 5D is a cross section of battery FIG. 5C after moving the fluid 540 to the other chamber.

### Conclusion

The ability to record usage history and future dispensation on a battery will provide a great convenience to the user and to the sighted and limited sight user and will promote conscientious recycling practices.

What I claim as my invention is a means and method for convenient marking of an article or battery which includes;

1. I claim a means for visual and tactile indicium marking of a battery or article which records known information about said article on said article by areas of coatings which can be easily modified by persons having unique knowledge of said article and desiring to convey said knowledge to persons having future contact with said article.

2. I claim a means for visual and tactile indicium marking of a battery or article which records known information about said article on said article by said article having tabs of removable material attached to said article which can be easily removed by person having unique knowledge of said article and desiring to convey said knowledge to persons having future contact with or use of said article.

3. I claim a means for visual and tactile indicium marking of a battery or article which records known information about said article on said article by said article having on its surface, a bladder or chamber containing a colored fluid and constrained by a covering transparent or translucent film and which said bladder can be ruptured by person having unique knowledge of said article and desiring to convey said knowledge to persons having future contact with or use of said article by virtue of dispersion of said fluid.

4. 1 claim a means for visual and tactile indicium marking of a battery or article which records known information about said article on said article by said article having an elongated membrane forming a tear strip attached to or imbedded into surface of said article and being capable of being easily removed from said article by avulsion of said membrane by person having unique knowledge of said article and desiring to convey said knowledge to persons having future contact with or use of said article.

5. I claim a means for visual and tactile indicium marking of a battery or article which records known information about said article on said article by persons having unique knowledge of said article and desiring to convey said knowledge to persons having future contact with or use of said article by having on its surface, a movable quantity of a viscous fluid which can be positioned to obscure undesired messages and expose desired messages on surface of said article and said fluid being constrained behind, beneath or within a retaining transparent or translucent membrane or film.
